(19) United States
(12) Patent Application Publication
(10) Pub. No.: US 2018/0288344 A1
(43) Pub. Date: Oct. 4, 2018

(54) SYSTEMS AND METHODS FOR DYNAMIC VOLTAGE SCALING OF AN IMAGE SIGNAL PROCESSOR

(71) Applicant: QUALCOMM Incorporated, San Diego, CA (US)

(72) Inventors: Jeffrey Hao Chu, San Diego, CA (US); Suolong Dong, San Diego, CA (US)

(21) Appl. No.: 15/472,149

(22) Filed: Mar. 28, 2017

(51) Int. Cl. H04N 5/369; G06T 1/20; H04N 5/378

(52) U.S. Cl. CPC H04N 5/3698; H04N 5/378; G06T 1/20

(57) ABSTRACT

Systems and methods for switching voltage operating points of an image signal processing pipeline are provided. The method comprises capturing an image during a sensor frame time. The method further comprises storing a plurality of pixels associated with the captured image. The method further comprises reading a first set of plurality of pixels within the sensor frame time. The method further comprises processing the first set of plurality of pixels and count a first set of plurality of pixels. The method further comprises comparing the count value with a pixel threshold value. The method further comprises, in response to the pixel count value reaching the pixel threshold value, switching the image signal processing pipeline from a first voltage operating point to a second voltage operating point.

### BACKGROUND

### Field

The present application relates generally to image processing, and more specifically to systems, methods, and devices for dynamic voltage scaling at an image signal processor (ISP) during a sensor frame time.

### Background

Today, video capture processes and hardware are being pushed to the edge with high-resolutions and high frame-rates in stand-alone imaging systems and cameras that are included on mobile devices, e.g., cell phones and tablets. While these advances improve user experience, they also present several challenges to device manufacturers, including increased power consumption. For example, as high-resolution sensors used in such imaging systems and devices continue to increase exponentially to 16 megabytes and above for both video and still-pictures, corresponding higher-end image signal processors are needed to effectively support the processing of the high through-put of such applications (e.g., via processing more image pixels per second or frames per second). This can cause the system-on-chips (SOCs) performing this processing to generate an undesired level of heat, large power consumption, fast battery drain, and/or slow image processing rates.

Reducing voltage and/or frequency levels at an imaging device can reduce heat generation and increase battery power. However, given the finite amount of power available on a mobile device, improved methods and systems are needed that deliver the video resolution and frame rates allowed by modern hardware capabilities while ensuring these hardware capabilities do not adversely impact the user experience with regard to power consumption and/or device temperatures, and therefore, in some aspects, battery life and/or image processing speeds.

### SUMMARY

The systems, methods, and devices of the invention each have several aspects, no single one of which is solely responsible for its desirable attributes. Without limiting the scope of this invention as expressed by the claims which follow, some features will now be described briefly. After considering this discussion, and particularly after reading the section entitled “Detailed Description,” one will understand how the features of this invention provide advantages that include improved communications between access points and stations in a wireless network. Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the present application provides an apparatus comprising a sensor configured to capture an image during a sensor frame time. The apparatus further comprises a memory buffer configured to store a plurality of pixels associated with the captured image. The apparatus further comprises an image signal processing pipeline operating at a first voltage operating point, including a processing unit, coupled to the memory buffer and configured to read a first set of plurality of pixels within the sensor frame time. The processing unit is further configured to process the first set of plurality of pixels and count a first set of plurality of pixels and compare the count value with a pixel threshold value. The apparatus further comprises a voltage regulator, coupled to the image signal processing pipeline, configured to, in response to the pixel count value reaching the pixel threshold value, switch the image signal processing pipeline from a first voltage operating point to a second voltage operating point.

Another aspect of the present application provides a method for switching voltage operating points of an image signal processor (ISP). The method comprises capturing an image, at a sensor, during a sensor frame time. The method further comprises identifying first and second voltage operating points for driving the ISP, wherein the first voltage operating point is lower than the second voltage operating point. The method further comprises receiving, from the sensor, a plurality of pixels associated with the captured image. The method further comprises transmitting, to the ISP, a first set of pixels of the plurality of pixels for processing the first set of pixels at the first voltage operating point within the sensor frame time. The method further comprises storing a second set of pixels of the plurality of pixels, wherein the second set of pixels contributes to a pixel count value. The method further comprises comparing the pixel count value with a pixel threshold value. The method further comprises, in response to the pixel count value reaching the pixel threshold value, switching the ISP to operating at the second voltage operating point and transmitting the second set of pixels to the ISP for processing the second set of pixels at the second voltage operating point within the sensor frame time.

Another aspect of the present application provides an apparatus for switching voltage operating points of an image signal processing pipeline. The apparatus comprises means for capturing an image during a sensor frame time. The apparatus further comprises means for storing a plurality of pixels associated with the captured image. The apparatus further comprises means for processing configured to: read a first set of plurality of pixels within the sensor frame time; process the first set of plurality of pixels and count a first set of plurality of pixels; and compare the count value with a pixel threshold value. The apparatus further comprises means for, in response to the pixel count value reaching the pixel threshold value, switching the image signal processing pipeline from a first voltage operating point to a second voltage operating point.

### BRIEF DESCRIPTION OF THE DRAWINGS

The disclosed aspects will hereinafter be described in conjunction with the appended drawings and appendices, provided to illustrate and not to limit the disclosed aspects, wherein like designations denote like elements.

FIG. 1 illustrates an imaging device in which one or more aspects of the present disclosure can be employed.

FIG. 2 illustrates an imaging device like that of FIG. 1, further including functional block diagram elements for one or more aspects that can be employed within the imaging systems disclosed herein.

FIG. 3 is an example data plot for an image signal processor voltage operating point and a buffer fill level at the imaging device of FIG. 2 against time, in accordance with an implementation.

FIG. 4 illustrates an imaging device like that of FIGS. 1 and 2, further illustrating an example power rail configuration and an example data flow, in accordance with one or more aspects of an implementation.

FIG. 5 illustrates an imaging device like that of FIGS. 1 and 2, further illustrating another example power rail configuration and another example data flow, in accordance with one or more aspects of an implementation.

FIG. 6 illustrates an imaging device like that of FIGS. 1 and 2, further illustrating another example power rail configuration and another example data flow, in accordance with one or more aspects of an implementation.

FIG. 7 is an example data plot for an image signal processor pixel rate and memory buffer fill level against time, in accordance with an implementation.

FIG. 8 is another example data plot for an image signal processor pixel rate and memory buffer fill level against time, in accordance with an implementation.

FIG. 9 is a flowchart of an example method for imaging, in accordance with one or more aspects of an implementation.

### DETAILED DESCRIPTION

Various aspects of the novel systems, apparatuses, and methods are described more fully hereinafter with reference to the accompanying drawings. The teachings disclosed may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to, or other than, the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different imaging technologies and system configurations and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In modern imaging devices (e.g., digital cameras), imaging sensor (or “sensor”) parameters (e.g., sensor pixel clock rates) typically drive image signal processor (ISP) parameters (e.g., ISP pixel clock rates). As described herein, an ISP may also be referred to as an “image processor,” an “imaging signal processor,” an “imaging processor,” an “image processing front end,” an “image front end,” an “imaging front end,” a “video processing front end,” a “video front end,” an “IFE,” a “VFE,” or any other variation thereto. As described herein, an ISP may include, for example, any circuitry component that connects to an imaging device interface, operates inline, and supports processing at the operation of the imaging device. An ISP may process image pixels in one or more domains, e.g., Bayer, RGB, YUV, etc. An ISP may collect pixel statistics for image processing tuning, for example, for downstream image processing tuning. As further described below, modern ISPs may process pixels at a clock rate (or “frequency”) equal to a pixel clock rate (or “frequency”) for a sensor associated with the imaging device. As one having ordinary skill in the art will appreciate, pixel clock rate (or “clock rate,” “frequency,” “operating frequency,” “clock frequency,” “pixel throughput,” etc.) may be directly related and/or “tied to” voltage operating point (or “voltage,” “voltage operating level,” “voltage level,” “voltage point,” “operating point,” “operating level,” etc.). For example, as the pixel clock rate for an ISP increases, the voltage operating point proportionally increases, and vice versa. Thus, as described herein, pixel clock rate (e.g., an input pixel clock rate, in MHz, for an ISP) and voltage operating point (e.g., for the ISP) may be referred to interchangeably. Further as described herein, “imaging” and “image processing” may be used interchangeably.

Modern high-resolution and/or high frequency sensors require high pixel clock rates, which further require high pixel clock rates (and thus, high voltage levels) at ISPs, so as to maintain necessary pixel throughput from the sensor and to avoid overflow, lost pixels, and/or image corruption. As many modern imaging devices install several, or all, of the other imaging components on the same voltage power rail as the ISP, these other imaging components are also required to operate at the same high voltage levels, despite having their own, often lower, power requirements.

As used herein, “coupled” may include communicatively coupled, electrically coupled, magnetically coupled, physically coupled, optically coupled, and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non□limiting examples. In some implementations, two devices (or components) that are communicatively coupled, such as in electrical communication, may send and receive electrical signals (digital signals or analog signals) directly or indirectly, such as via one or more wires, buses, networks, etc.

In other words, high pixel clock rates at the ISP requires high voltage operating points (i.e., frequencies) for other components operatively coupled with the ISP (e.g., on the same voltage power rail). Thus, in addition to the increased power requirements for the ISP, this even further increases total power consumption for the imaging device. As described above, voltage operating points (e.g., in volts), processing frequencies (e.g., in Hertz), clock rates (e.g., pixels processed per second) for imaging devices all have a direct relation. Thus, in addition to the interchangeable terms described above with respect to voltage operating points and pixel clock rates, voltage operating points, voltage levels, voltage corners, operating frequencies, clock rates, pixel clock rates, and the like, may also be described herein interchangeably with respect to imaging devices, ISPs, etc. Furthermore, as described herein, ISPs may also be referred to as a part or a whole of a system-on-chip, wherein the system-on-chip can include the ISP operatively coupled with an imaging sensor, among other imaging components installed on the system. A system-on-chip may also be referred to herein as an SoC, an Application Processor (AP), or otherwise.

Because chip manufacturers often cannot be certain of final product sensor operating requirements, modern ISPs are typically configured to operate only at fixed voltage operating points for an entire duration of a sensor frame (e.g., 33 ms). To decrease the risk of the ISP operating at insufficient levels during an image capture (for example), the ISPs are often configured to remain at these fixed operating levels for the entire duration of the sensor operation (e.g., for an entire sensor frame time). In particular, typical ISPs are configured to operate at fixed voltage operating points for the entire sensor frame time (i.e., the duration of sensor operations for a given image frame).

To help alleviate some of these issues, many ISPs can operate at multiple voltage operating points (e.g., 0.5V, 0.8V, 1.0V, etc.), for example, by separating groups of imaging components onto multiple power rails. As one example, some imaging devices include an additional power rail so as to isolate the ISP to its own power rail. Thus, although voltage levels remain high at the ISP, because other imaging components on the system-on-chip (e.g., the display engine) are connected to a different power rail, the other components are not also required to operate at the high voltage level. However, despite having multiple voltage operating points available, typical systems still operate the ISP at a fixed voltage level, which still results in wasted resources.

Other modern imaging systems include an additional ISP on the system-on-chip, which splits the operating frequency requirements between two ISPs, which then reduces maximum voltage requirements for the image processing aspect of the chip. However, adding additional ISPs increases costs, and programming complications increase when configuring multiple ISPs. Furthermore, including multiple ISPs increases device sizes. Further yet, typical systems configured in such a manner maintain the practice of operating each of the ISPs at fixed, albeit lower, voltages, which still results in wasted resources.

Yet other systems attempt to address the above issues by dumping raw sensor data into memory (e.g., DDR), which can bypass certain pixel processes. However, such systems require large memory bandwidths to read in images for image previews. Furthermore, such chip configurations increase system latency and often require high back end operating frequencies to handle modern frame rate requirements (e.g., 60 frames-per-second (FPS), 120 FPS, 240 FPS, etc.). In turn, such configurations increase system costs, system latencies, and potential frequency bottlenecks. Such systems often require large bandwidths for reading in images to generate previews and/or video streams, which increases latency along imaging preview paths.

Finally, other imaging systems implement dynamic clock and voltage scaling (DCVS) techniques to adjust voltage levels for certain components (e.g., the display engine) on a system-on-chip and/or an imaging device. However, as traditional imaging devices configure the ISP to always maintain a pixel processing rate equal to or greater than that being input by the imaging sensor (e.g., so as to not to fall behind, or lag, in processing), traditional imaging devices, even those implementing certain DCVS techniques, maintain fixed operating points at the ISP or ISPs. For example, due to the wide range of possible sensor pixel clock rates for the same image resolution, chip designers run the risk of falling short of desired frequencies (e.g., by several MHz), causing system-on-chip and ISPs to require operating at higher operating voltages to meet pixel clock rate requirements. Again, in such scenarios, several, if not all, of the other imaging components operatively coupled with the system-on-chip will then also be required to operate at the higher voltage operating point. Thus, even when modern imaging devices implement certain DCVS techniques, such imaging devices still waste power and reduce the benefits of the DCVS techniques. Thus, imaging devices with improved ISP voltage operating point configurations are desired.

To that end, systems and methods are provided for dynamically switching voltage operating points at an ISP, for example, so as to provide improved power efficiency over current imaging systems and methods without reducing visual performance. In short, the systems and methods described herein enable switching the voltage operating point for the ISP between voltage operating points such that an average operating frequency of the ISP is greater than or equal to an input frequency of the sensor and such that a lag time duration for displaying an image is reduced based on the ISP processing, within the sensor frame time, the total number of pixels at the average operating frequency. For example, during a sensor frame time, aspects herein describe an ISP configured to operate at a low voltage operating point (e.g., 0.5V) for a duration, switch to a high voltage operating point (e.g., 0.8V or 1.0V) for a duration, switch back to the low voltage operating point for a duration, and so on (e.g., power cycling). Based on the actual sensor pixel clock rate and/or the supported voltage operating plan of the associated processing chip, the durations can be determined such that the ISP operates at an average voltage that meets, but does not unnecessarily exceed, the required operating voltage to sufficiently process the pixels from the imaging sensor. In this way, the ISP can use less power on average than a typical ISP that operates at a fixed voltage operating point (e.g., 0.8V or 1.0V). Meanwhile, the ISP described herein can sufficiently process all of the incoming pixels from the sensor, and the average voltage operating point of the ISP can remain lower than if the ISP were configured to operate at a fixed, higher voltage, like traditional systems. Furthermore, the imaging device system described herein may operate without requiring installation of additional components on the system-on-chip (e.g., an additional power rail, an additional ISP, etc.).

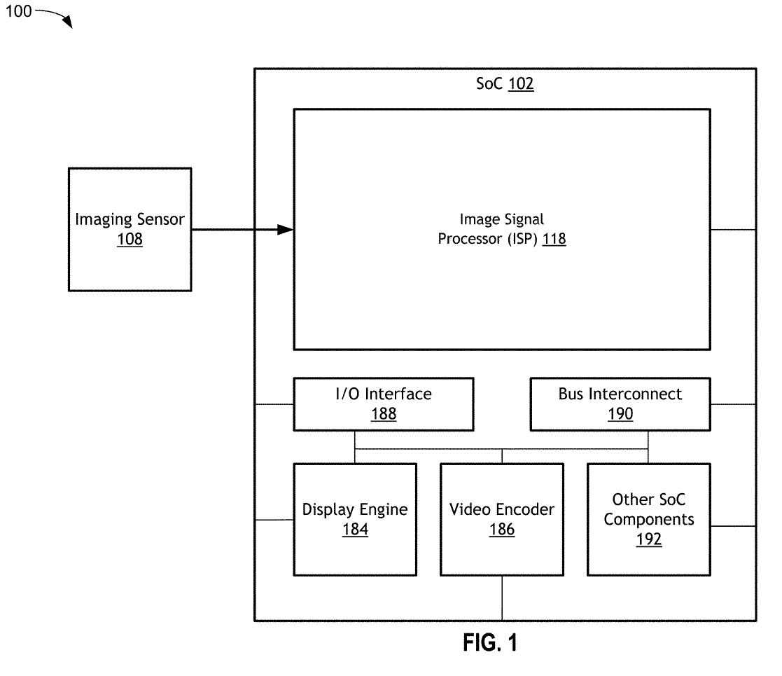

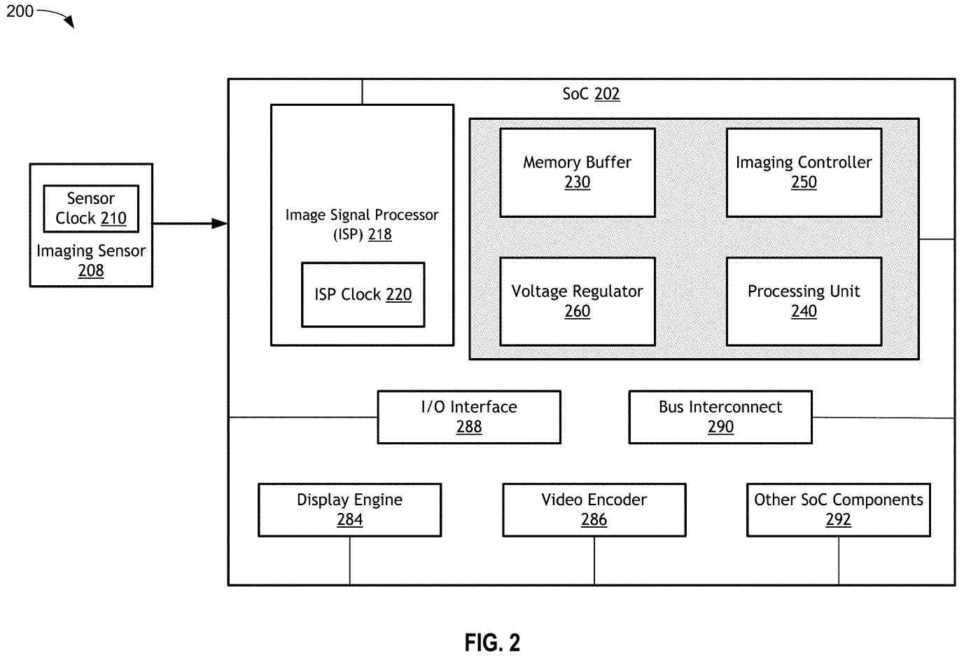

FIG. 1 illustrates an imaging device 100 in which aspects of the present disclosure can be employed. The imaging device 100 may include a system-on-chip 102 and an imaging sensor 108, among other components. The physical configuration of the various components as illustrated in FIG. 1 may represent one example embodiment for the imaging device 100. As one having ordinary skill in the art will appreciate, the physical configuration of the various components of the imaging device 100 can be arranged in any other configuration suitable for processing images. Certain non-limiting examples are described below and illustrated in connection with, for example, FIGS. 2 and 4-6.

With reference to FIG. 1, the system-on-chip 102 can include any number of components configured to perform, alone or in combination with one another, the various functionalities of the imaging device 100. Some or all of the components can be electrically coupled to and/or communicate with one another, for example, via a bus interconnect 190. The bus interconnect 190 may include a data bus, for example, as well as a power bus, a control signal bus, and a status signal bus in addition to the data bus. Those of skill in the art will appreciate that various components of the system-on-chip 102 may be coupled together or accept or provide inputs to each other using some other mechanism. The system-on-chip 102 can further include a display engine 184, a video encoder 186, an input-and-output interface 188, and any number of other system-on-chip components 192 for performing various functionalities of the imaging device 100.

The imaging sensor 108 may include an array of electronic imaging elements, for example, disposed in an imaging plane, and the array may include millions or tens of millions (or more) of imaging elements. Each imaging element may be configured to receive incident light (e.g., photons) and generate a signal based on the light incident on the imaging element. The imaging sensor 108 may be, for example, a Complementary metal-oxide-semiconductor (CMOS) sensor, a charge coupled device (CCD) sensor, or another type of sensor. The image signal processor (ISP 118) can be coupled to, and in electronic communication with, the imaging sensor 108, and may receive image information from the imaging sensor 108 of a target scene captured by the imaging sensor 108. In some embodiments, the system-on-chip 102 may include, or be incorporated into, the imaging device 100, which can be a standalone camera, a mobile device or a cell phone having a camera, a camera module, medical imaging equipment, night vision equipment such as thermal imaging devices, radar, sonar, others configurations of computers (e.g., laptops, tablets, etc.) and/or imaging devices, etc.

The system-on-chip 102 can include an ISP 118, which can comprise, for example, circuitry for the camera image processing aspects of the imaging device 100, as described above. In one non-limiting example, the circuitry can be referred to as front end circuitry. The ISP 118 can receive real-time image data (e.g., over a data stream) from the imaging sensor 108. For example, the ISP 118 can receive image pixels from the imaging sensor 108 and/or a memory buffer (as described herein in reference to FIG. 2) for processing at the ISP 118. As described herein, a memory buffer may be referred to as providing data (or transmitting data) to another component, which one having ordinary skill in the art will understand can include, for example, the data having been stored at and/or written to the memory buffer and the another component reading the stored data from the memory buffer. Similarly, as described herein, a memory buffer may be referred to as receiving data from another component, which one having ordinary skill in the art will understand can include, for example, the data being written to and/or stored at the memory buffer and the another component writing and/or storing the data at the memory buffer. Based on the processing during the sensor frame time and voltage switching further described below, the system can reduce a lag time duration for displaying the image data. For example, in general, the ISP 118 is configured to process pixels from the imaging sensor 108 at a rate equal to or greater than that of the input rate of the imaging sensor 108. The image information communicated from the imaging sensor 108 to the ISP 118 may include image data, for example, data that represents the signal information generated by the array of imaging elements of the imaging sensor 108 from light received from a target scene.

The components operatively coupled with the system-on-chip 102 (e.g., the ISP 118 and the other system-on-chip components 192) can be driven at a voltage operating point according to design parameters of the system-on-chip 102. In some aspects, the system-on-chip 102 can include multiple power rails for driving different components included on the system-on-chip 102 at different voltage operating points. For example, all of the components of the system-on-chip 102 may be installed on the same power rail; and thus, all of the components of the system-on-chip 102 may operate at the same voltage level. In some aspects, some of the components of the system-on-chip 102 may be installed on separate power rails and thus operate at different voltage levels. In some aspects, all of the components of the system-on-chip 102 may operate on a single power rail.

As a person of ordinary skill in the art will appreciate, the imaging device may also include other components but are not illustrated for clarity of FIG. 1. These components may include, but are not limited to, a lens assembly, one or more apertures, control circuitry for transferring the signals generated by the imaging sensor 108 to the ISP 118, electronic storage (memory), and/or any other imaging and/or processing-based components. Such components may be included in embodiments of the invention without departing from the scope of this disclosure. Some components of the imaging device 100 not illustrated in the example shown in FIG. 1 are illustrated in, and described in reference to, FIGS. 2-7.

The system-on-chip 102 may be a specialized digital signal processor (DSP) used for imaging applications in digital cameras, mobile phones or other devices. The system-on-chip 102 may employ parallel computing with single instruction, multiple data (SIMD) or multiple instruction, multiple data (MIMD) technologies to increase speed and efficiency through processing using a number of processors that function asynchronously and independently. At any time, different processors may be executing different instructions on different pieces of data. In some aspects, to increase the system integration on embedded devices, the system-on-chip 102 may comprise a multi-core processor architecture.

FIG. 2 illustrates an imaging device 200 (e.g., similar to that of the imaging device 100 described in connection with FIG. 1), further illustrating functional block diagram elements for aspects that can be employed within the imaging systems disclosed herein. The imaging device 200 is an example of a device that can be configured to implement the various methods described herein. With respect to the description of FIG. 2 herein, some of the item numbers may refer to the so-numbered aspects described above in connection with FIG. 1. For example, a system-on-chip 202 (or “the system”), an imaging sensor 208, an image signal processor (ISP) 218, an input-and-output interface 288, a bus interconnect 290, a display engine 284, a video encoder 286, and other system-on-chip components 292, may comprise, respectively, the system-on-chip 102, the imaging sensor 108, the ISP 118, the input-and-output interface 188, the bus interconnect 190, the display engine 184, the video encoder 186, and the other system-on-chip components 192, described in connection with FIG. 1.

The imaging sensor 208 may further include a sensor clock 210, which as described above, can regulate the rate at which the imaging sensor 208 outputs pixels to the ISP 218 and/or a memory buffer 230. Similarly, the ISP 218 may further include an ISP clock 220, which can regulate the rate at which the ISP 218 can process incoming pixels from the imaging sensor 208 and/or the memory buffer 230. The ISP 218 may further comprise and/or be operatively coupled to additional components for performing one or more of the aspects described herein, e.g., the memory buffer 230, an imaging controller 250, a voltage regulator 260, a processing unit 240, among other imaging and processing components. The memory buffer 230 can buffer slices of an image frame (e.g., lines of pixels) along the image path from the imaging sensor 208 to the processing unit 240 and/or the ISP 218. In an aspect, the processing unit 240 can monitor pixel count values and/or pixel fill levels at the memory buffer 230, as further described herein. In an aspect, the memory buffer 230 can comprise DDR, cache, system cache, on-chip memory, etc. The imaging controller 250 can perform certain operations in connection with the voltage scaling aspects described herein in connection with one or more of the ISP 218, the ISP clock 220, the memory buffer 230, the processing unit 240, etc. In one embodiment, the processing unit 240 can be located within a data control portion of the imaging processing device 200. The data control portion can be electrically connected in parallel with the ISP 218, for example. In another embodiment, the processing unit 240 can be a part of a data path (not explicitly pictured in FIG. 2) for the imaging processing device 200 and/or the ISP 218. In an aspect, when the processing unit 240 is a part of the data path for the imaging processing device 200, the processing unit 240 can be located near the beginning of the data path.

The imaging controller 250 may further include or be operatively coupled with the voltage regulator 260. The voltage regulator 260, as described herein, can dynamically (e.g., in real-time and/or within a sensor frame time) switch voltage operating points at the ISP 218 such that an average voltage or frequency operating point at the ISP 218 (e.g., a rate at which the ISP 218 processes input pixels) can be greater than or equal to the pixel input frequency of the imaging sensor 208. Again, given their direct relation, the pixel input frequency may interchangeably be referred to as the pixel clock rate, the operating frequency, pixel throughput, output pixel throughput, operating pixel throughput, and/or the operating voltage for one or both of the ISP 218 and the ISP clock 220. Similarly, the pixel output frequency may interchangeably be referred to as the pixel clock rate, the operating frequency, pixel throughput, output pixel throughput, operating pixel throughput, and/or the operating voltage for one or both of the imaging sensor 208 and the sensor clock 210. In an alternative embodiment, the methods described herein may be implemented from the perspective of the imaging sensor 208, rather than from the perspective of the ISP 218.

Although a number of separate components are illustrated in FIG. 2, those of skill in the art will recognize that one or more of these components may be implemented not only with respect to the functionality described above, but alternatively, or in addition, to implement the functionality described above with respect to other components. For example, the ISP 218 may be used to implement not only the functionality described herein with respect to the ISP 218, but also to implement the functionality described herein with respect to one or more of the memory buffer 230, the imaging controller 250, the voltage regulator 260, the processing unit 240, etc. Each of the components illustrated in FIG. 2 may be implemented using a plurality of separate elements.

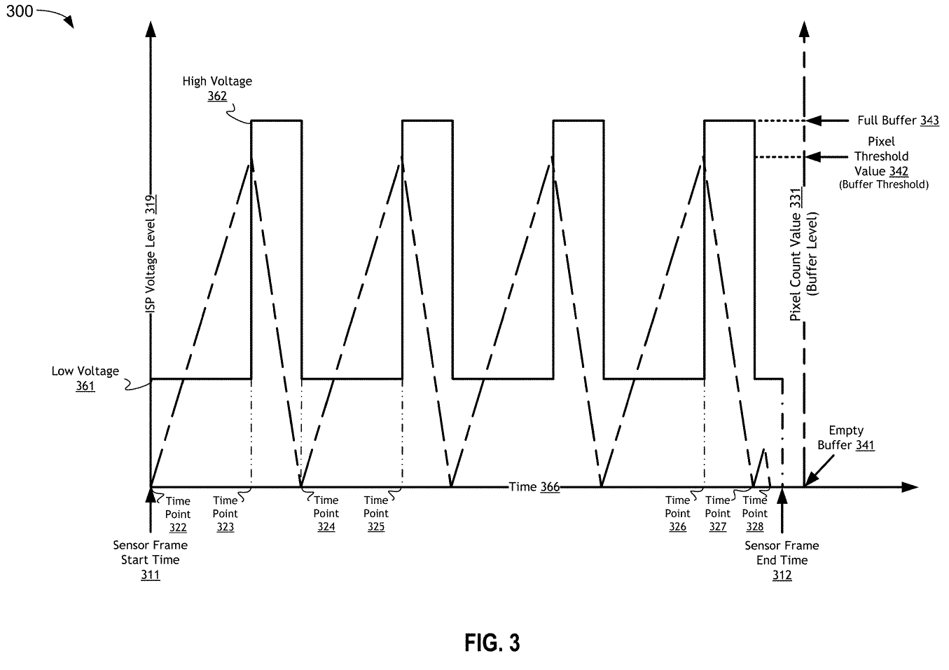

FIG. 3 is an example data plot 300 of a ISP (e.g., the ISP 118 or the ISP 218) voltage operating point and a buffer (e.g., the memory buffer 230) fill level at an imaging device (e.g., the imaging device 100 or the imaging device 200) against time, in accordance with an implementation. With respect to the description of FIG. 3 herein, some of the item numbers may refer to the so-numbered aspects described above in connection with FIGS. 1 and 2. As described further below, the buffer fill level may refer to a number of pixels (or a “pixel count value”) stored in a buffer, e.g., the memory buffer 230.

As an example, the system-on-chip 202 may have multiple voltage operating points, each of the voltage operating points being associated with a different maximum processing frequency. For instance, the system-on-chip 202 may have a low voltage operating point (e.g., 0.63V and 400 MHz) and a high voltage operating point (e.g., 0.72V and 480 MHz), which may also be referred to as the low voltage level 361 (or “first voltage operating point”) and the high voltage level 362 (or “second voltage operating point”), respectively. An ISP voltage level axis 319 illustrates an ISP voltage level for a power rail operatively coupled to the ISP 218. In association with the ISP voltage level axis 319, an example low voltage level and an example high voltage level are illustrated in FIG. 3 as a low voltage level 361 and a high voltage level 362. The voltage level over time (e.g., as indicated by a time axis 366) is illustrated via the solid line on the data plot 300.

Continuing with the above example, the system-on-chip 202 may possess certain configuration parameters related to the imaging sensor 208 (as further described below), the sensor parameters including, for example, an active pixel width for the sensor (e.g., 5,500 pixels), a frame width (e.g., 7,400 pixels), and a pixel clock rate (e.g., 560 MHz). In a traditional imaging system, given the above sensor parameters, the pixel output rate of the sensor may be calculated as over 400 MHz. As further described below, a low voltage operating point of the ISP may be insufficient for an example ISP to handle an entirety of a sensor output. Thus, traditional imaging devices would typically be configured to operate at a high voltage operating point for the ISP (e.g., 480 MHz) for an entire sensor duration.

Instead, as illustrated in FIG. 3, as described herein, the ISP 218 can be dynamically switched to operate at different voltage operating points during a sensor frame time (e.g., for the imaging sensor 208). As one example, the voltage regulator 60 can be configured to identify first and second voltage operating points for driving the ISP 218, wherein the first voltage operating point is lower than the second voltage operating point. The sensor frame time can extend from a sensor frame start time 311 until a sensor frame end time 312. The imaging sensor 208 can be configured to capture an image during the sensor frame time. Thus, in an aspect, the memory buffer 230 can be configured to receive, from the imaging sensor 208, a plurality of pixels associated with the captured image. Thereafter, the memory buffer 230 can provide, to the ISP 218, a first set of pixels of the plurality of pixels for processing the first set of pixels at the first voltage operating point within the sensor frame time. The memory buffer 230 can store (“buffer”) certain of the incoming pixels (e.g., a second set of pixels) of the plurality of pixels. In an aspect, the stored pixels can contribute to a pixel count value, as represented by a pixel count value axis 331. Further during the sensor frame time, the ISP 218 can input the pixels from the memory buffer 230 for processing at the ISP 218.

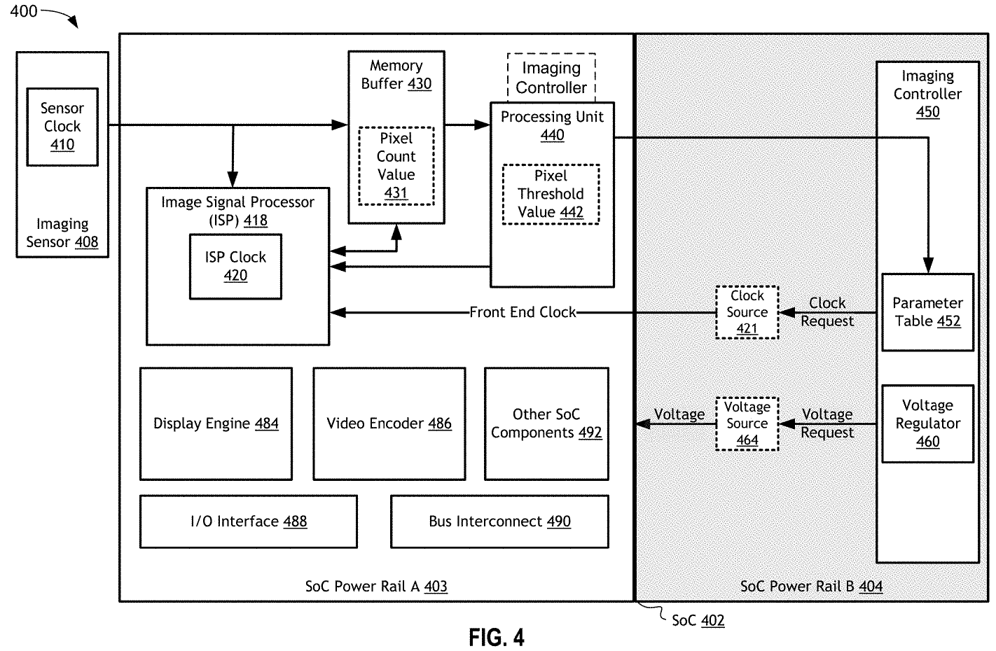

As illustrated by the dashed line, at a time point 322, the memory buffer 230 starts with an empty buffer level 341. Between the time point 322 and a time point 323, the memory buffer 230 continues to receive pixels from the imaging sensor 208 (as illustrated by the buffer level increasing) and continues to provide a portion of the incoming pixels (e.g., first sets of pixels) to the ISP 218 for processing. During this time, the ISP 218 operates at the low voltage level 361. When operating at the low voltage level 361, the ISP 218 may be capable of processing only a portion of the incoming pixels from the imaging sensor 208 and/or the memory buffer 230. The memory buffer 230 may thus be configured to store the remaining, unprocessed portion (“second set of pixels) of the incoming pixels in the memory buffer 230. In response, the memory buffer 230 may be configured to update a pixel count value based on the unprocessed pixel portions. The system may continue in this way until the buffer level reaches a threshold, e.g., at the time point 323 where the pixel count value reaches the pixel threshold value 342. As described herein, the pixel count value (e.g., as represented by the pixel count value axis 331 in FIG. 3) may also be referred to as a “buffer level,” a “pixel count,” or the like. As described herein, the pixel threshold value 342 may also be referred to as a “pixel threshold,” “buffer threshold,” “pixel threshold level,” “buffer threshold level,” “threshold level,” “threshold value,” etc. When the pixel count value reaches the pixel threshold value, the system (e.g., via the voltage regulator 260) may switch the ISP 218 to the high voltage level 362, as further described below with reference to FIGS. 4-7. While operating at the high voltage level 362, the ISP 218 may be capable of processing all of the incoming pixels from the imaging sensor 208 as well as incrementally processing the pixels stored in the memory buffer 230. When the buffer is empty (e.g., at the time point 324), the ISP 218 can be switched back to the low voltage level 361 and start the process again (e.g., at the time point 324). In this way, the ISP 218 may operate, on average, at a sufficient average voltage operating level for handling the incoming pixels from the imaging sensor 208, while maintaining the low voltage level 361 for a majority of the time (65% of the time, or 90% of the time, for example).

As further described below, the system may determine the pixel threshold value 342 based on, for example, the low voltage level 361, the high voltage level 362, and the sensor parameters. The derivation of the pixel threshold value 342 is described in connection with FIG. 4. In general, the system-on-chip 202 may determine that the ISP 218 can sufficiently handle the pixel output rate from the imaging sensor 208 by operating at the low voltage level 361 (e.g., 400 MHz) for the majority of the sensor operating time (e.g., 90% of the time) and then operating at the high voltage level 362 (e.g., 480 MHz) for the remainder of the sensor operating time (e.g., 10% of the time), on average. While operating at the low voltage level 361, the memory buffer 230 can store a portion of the incoming pixels (and update the pixel count value based on the portion of the pixels processed or not processed), as indicated by the pixel count value axis 331. The processing unit 240 may determine one or more of the pixel threshold value 342 and the real-time buffer levels (e.g., the pixel count value). Thus, the processing unit 240, in connection with the memory buffer 230, can be configured to compare the pixel count value with a pixel threshold value, as further described below in connection with FIG. 4. In response to the pixel count value (i.e., the number of pixels stored in the memory buffer 230) reaching the pixel threshold value 342, the voltage regulator 260 can cause the ISP 218 to switch to operating at the high voltage level 362.

Thereafter, the memory buffer 230, further in response to the pixel count value reaching the pixel threshold value, can provide the stored pixels to the ISP 218 for processing at the high voltage level 362 within the sensor frame time. While operating at the high voltage level 362, the ISP 218 may process all of the incoming pixels from the imaging sensor 208 (e.g., bypassing storage at the memory buffer 230), in addition to processing portions of the incoming second set (previously stored) pixels from the memory buffer 230 (e.g., thereby reducing the pixel count value accordingly). The ISP 218 may continue in this way until the buffer at the memory buffer 230 is empty (e.g., the empty buffer level 341). Then the ISP 218 can switch back to the low voltage level 361.

As an illustrative example, the memory buffer 230, before providing the second set (previously stored) of pixels to the ISP 218, can provide, to the ISP 218, one or more additional sets of pixels of the plurality of pixels for processing at the first voltage operating point within the sensor frame time. For each of the one or more additional sets of pixels provided to the ISP 218, the memory buffer 230 can store a further set of pixels, wherein each of the further sets of pixels contributes to the pixel count value. This is illustrated in FIG. 3 as the positive sloped dashed lines increasing along the pixel count value axis 331, for example, from the time point 322 to the time point 323. In response to the pixel count value reaching the pixel threshold value 342, the ISP 218 can be switched to operating at the high voltage level 362, and the memory buffer 230 can then provide each of the further sets of pixels to the ISP 218 for processing at the high voltage level 362 within the sensor frame time (e.g., within the time from the sensor frame start time 311 and the sensor frame end time 312). Each time the memory buffer 230 provides one of the further sets of pixels or the second set of pixels to the ISP 218, the corresponding number of pixels can be deducted from the pixel count value upon transmission. This is illustrated in FIG. 3 as the negative sloped dashed lines decreasing along the pixel count value axis 331, for example, from the time point 323 to the time point 324. Thereafter, the voltage regulator 260, in response to the pixel count value reaching the empty buffer level 341, or “zero,” (e.g., at the time point 324), can switch the ISP 218 back to operating at the first voltage operating point.

In an aspect, the voltage regulator 260 can initiate the above described voltage operating point switches at the ISP 218 and the memory buffer 230 can perform the above described operations until a total number of pixels processed by the ISP 218 within the sensor frame time is equal to a number of the plurality of pixels received at the memory buffer 230 from the imaging sensor 208. This is illustrated in FIG. 3 as the dashed line increasing and decreasing continuously according to the methods described above until the time point 328, when the memory buffer 230 is empty, and shortly thereafter, the frame time ends at the sensor frame end time 312.

In this way, and as described above, the voltage regulator 260 is configured to switch the voltage operating point for the ISP 218 between the first and second (“high and low”) voltage operating points such that an average operating frequency (not pictured) of the ISP 218 is greater than or equal to an input frequency of the sensor (e.g., based on the pixel clock rate of the sensor clock 210) and such that a lag time duration for displaying the image (e.g., via the display engine 284) is reduced based on the ISP 218 processing, within the sensor frame time, the total number of pixels at the average operating frequency.

As a non-limiting example, the systems and methods described herein can enable the ISP 218 to eliminate frame delay (e.g., related to the imaging sensor 208) as compared to other methods that include storing pixel data from a sensor in a memory (e.g., double data rate (DDR) memory) before being read from the DDR and processed, for example, by the ISP. Thus, as described above, the systems and methods described herein can enable reducing lag for displaying an image via the imaging processing device 200. For example, the memory buffer (e.g., the memory buffer 230) can be static random-access memory (SRAM), local storage, or some other kind of memory that is capable of storing small portions of the image (e.g., in accordance with a memory storage capability of the memory buffer 230) without creating delay for displaying the image. As described above, this can allow for a lag time duration for displaying the image to be reduced to within a frame time of the imaging sensor 208.

In an embodiment, the system is configured to avoid completely filling the buffer (e.g., allowing the memory buffer 230 to reach a full buffer level 343), so as to allow for buffer drain times and voltage switching times (e.g., ramp-up and/or ramp-down times). For example, switching from the low voltage level 361 to the high voltage level 362 may take the ISP 218, for example, 150 microseconds. Thus, the full buffer level 343 may be greater than the pixel threshold value 342 in order to compensate for at least 15 pixel lines (e.g., 10 microseconds per pixel line), in one example, and as further described below.

Portions of the above non-limiting examples are illustrated in FIG. 3. That is, at a time point 322 (i.e., the sensor frame start time 311), the memory buffer 230 is at the empty buffer level 341, and the ISP 218 operates at the low voltage level 361. At a time point 323, the number of stored pixels (i.e., the pixel count value) reaches the pixel threshold value 342, and the ISP 218 can switch to the high voltage level 362 so as to clear the memory buffer 230. While still receiving pixels from the imaging sensor 208, the ISP 218 processes the incoming pixels while clearing the memory buffer 230, during the duration starting at time point 323 and ending at a time point 324, where the memory buffer 230 is at the empty buffer level 341. Thus, at the time point 324, the ISP 218 can switch back to the low voltage level 361. The ISP 218 can proceed in a similar fashion across the data plot 300, for example, by switching again to the high voltage level 362 when the memory buffer 230 is at the pixel threshold value 342 at a time point 325 (and a time point 326, among others), and by switching again to the low voltage level 361 when the memory buffer 230 is at the empty buffer level 341, for example, at a time point 327. As illustrated, the sensor frame ends at a sensor frame end time 312. Thus, the ISP 218 will no longer receive pixels from the imaging sensor 208 and will be able to quickly process the remaining pixels. This is indicated by the dashed lines at the time point 327 until a time point 328. As is shown in FIG. 3, the system allows for the ISP 218 to dynamically switch voltage levels (e.g., power cycle) during a sensor frame time.

The system can be configured to calculate the pixel threshold value 342 in real-time (e.g., during the sensor frame time duration from the sensor frame start time 311 until the sensor frame end time 312), using proprietary formulas, based on associated parameters for the imaging sensor 208, the low voltage level 361, and the high voltage level 362. The low voltage level 361 and the high voltage level 362 may be included in a frequency plan for the system-on-chip 202 in association with one or more power rails for the system-on-chip 202, as further described in connection with FIG. 4 below. In an embodiment, the ISP 218 can utilize a first-in-first-out (FIFO) method for inputting pixels.

The sensor configuration parameters for the imaging sensor 208 can comprise, for example, an active pixel width (or “activity width” or “ActiveWidth”), a frame width (or “FrameWidth”), a horizontal blank value (or “HBLANK”), and an output clock rate in MHz (or “OPCLK” or “OP_CLK”). For example, ActiveWidth can represent a standard number of pixels in a horizontal image line from the imaging sensor 208. Values for the sensor configuration parameters (e.g., for the imaging sensor 208) could include, for example, 5488 active pixel clocks, 7352 total pixel clocks, 1864 horizontal blanking pixels, and 561.6 MHz, respectively. HBLANK may represent, for example, a duration of inactive pixels in an image line, e.g., separation of image lines in time. In some instances, HBLANK parameters may be used to reduce pixel clock rates at the system-on-chip 202. As one example, an image line may comprise 5,488 active pixel clocks (e.g., ActiveWidth) and 7,352 total pixel clocks (e.g., FrameWidth). In this example, with a single line buffer (e.g., one example embodiment of the memory buffer 230) used as a storage medium, and an output clock rate (e.g., OPCLK) of 561 MHz, the pixel clock of the ISP (e.g., ISP_Rate), for example, the ISP 218, may be calculated to be 419 MHz according to Equation 1. Additional examples and equation variations are demonstrated below.

$$( \frac{ActiveWidth}{FrameWidth} ) * OPCLK = {ISP}_{Rate} = ( \frac{5488 width}{7352 width} ) * 561 MHz = 419 MHz \qquad ( 1 )$$

Operating parameters for the system-on-chip 202 (and thereby the ISP 218) can include, for example, a low voltage operating point (e.g., the low voltage level 361), a high voltage operating point (e.g., the high voltage level 362), a maximum supported frequency (e.g., Fmax1) for the ISP 218 at the high voltage level 362 (e.g., “ISPCLK1” or “fast clock rate”), a maximum supported frequency (e.g., Fmax2) for the ISP 218 at the low voltage level 361 (e.g., “ISPCLK2” or “slow clock rate”)

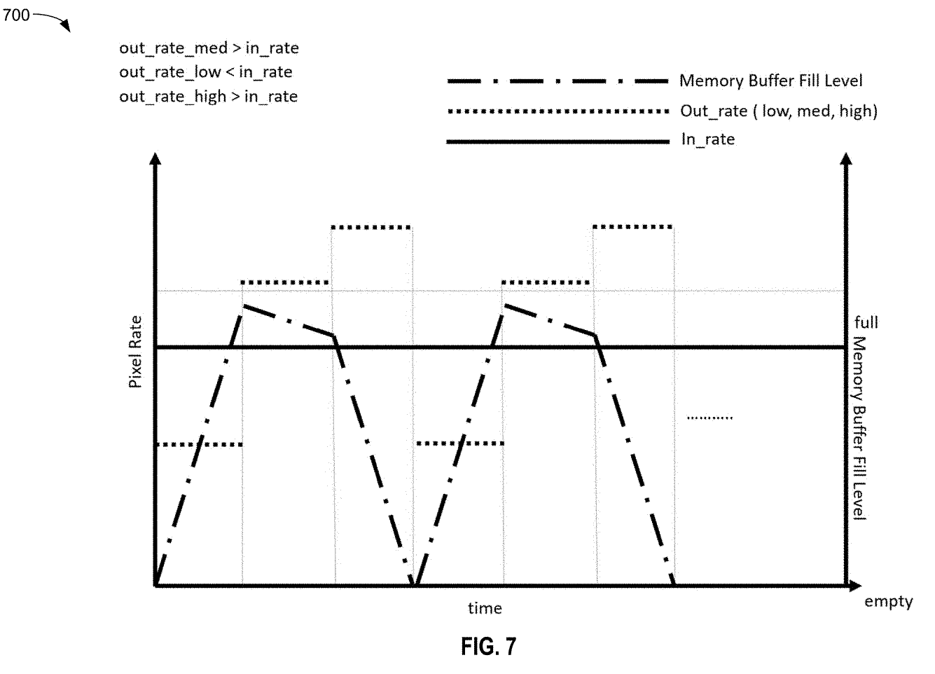

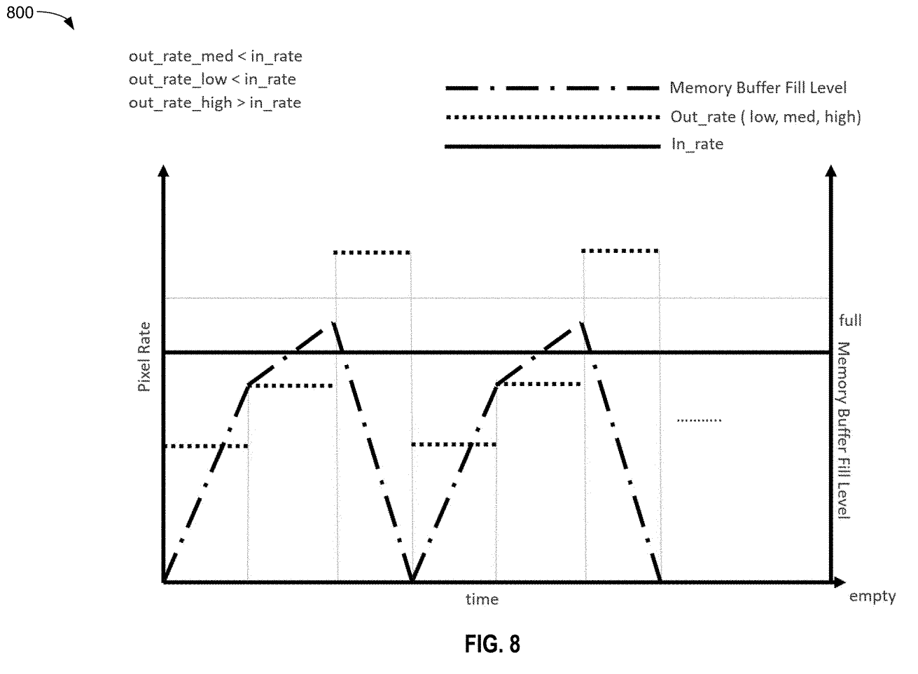

In some aspects, the system-on-chip 202 can operate at more than two voltage operating points. For example, the system-on-chip 202 could operate at five different operating points Example voltage levels and associated maximum operating frequencies (e.g., “ISPCLK”) for the voltage level could include, for example, the values as shown in Table 1. Collectively, Table 1 can represent an example frequency plan for the system-on-chip 202. FIGS. 7 and 8 provide additional examples when the system-on-chip 202 operates at multiple voltage operating points.

TABLE 1

| System-on-Chip 202 | Voltage | Maximum clock |
|---|---|---|
| Voltage Operating Point | Level (V) | frequency (MHz) |
| Operating point 1 | 0.856 | 600 |
| Operating point 2 | 0.752 | 600 |
| Operating point 3 | 0.684 | 480 |
| Operating point 4 | 0.628 | 404 |
| Operating point 5 | 0.572 | 200 |

Given the frequency plan and the sensor parameters, the system-on-chip 202, in conjunction with one or more of the memory buffer 230, the imaging controller 250, the voltage regulator 260, the processing unit 240, and/or the ISP 218, can determine the pixel threshold value 342 (e.g., “ActiveWidthSlow” or the “active width at low voltage”) for achieving the operations illustrated in FIG. 3 and so as to minimize power at the ISP 218, and thus, the system-on-chip 202.

For example, in general, as described above, the pixel processing rate for the ISP 218 (e.g., “ISP_Rate”) must be greater than or equal to the pixel output rate from the imaging sensor 208 (e.g., “SensorOutputRate”). Thus, since “ISP_Rate” must be greater than or equal to “SensorOutputRate,” Equation 2 can be derived. Equation 2 is another form of Equation 1.

$${ISP}_{Rate} = \frac{ActiveWidth * OPCLK}{FrameWidth} , \qquad ( 2 )$$

which provides for the output pixel clock rate of the imaging sensor 208, given the parameters described above. Given this, Equation 3 can be derived.

$${ISP}_{Rate} = \frac{ActiveWidth}{( \frac{ActiveWidthSlow}{ISPCLK 1} ) + ( \frac{ActiveWidthFast}{ISPCLK 2} )} , \qquad ( 3 )$$

further based on the parameters described above. Finally, the pixel threshold value 342 (“ActiveWidthSlow”) can be equated as shown in either of Equations 4 or 5.

$$\frac{ISPCLK 1 * ( ActiveWidth - ActiveWidthSlow )}{ISPCLK 2 * ( \frac{ISPCLK 1 * FrameWidth}{OPCLK * ActiveWidthSlow} ) - 1} ; \qquad ( 4 )$$

or

$$( \frac{1}{ISPCLK 2 - ISPCLK 1} ) ( \frac{ISPCLK 1 * ISPCLK 2 * FrameWidth}{OPCLK} - ISPCLK 1 * ActiveWidth ) \qquad ( 5 )$$

Thus, by determining the pixel threshold value 342, the system-on-chip 202 and the ISP 218 can effectively match the sensor output pixel rate (e.g., on average), over the entire frame duration (e.g., from the sensor frame start time 311 to the sensor frame end time 312), while operating at the low voltage level 361 (e.g., thus a lower pixel clock rate) for the majority of the duration. Such power cycling allows power savings over a system operating at only the high voltage level 362, for example.

The pixel threshold value 342 (e.g., ActiveWidthSlow) may be utilized to compute the full buffer level 343, for example, based on parameters of the imaging sensor 208 and/or operating points of the system-on-chip 202. The pixel threshold value 342 may also incorporate overheard from the system-on-chip 202, for example, related to a time for changing voltage levels (e.g., of the ISP 218). Thus, in an aspect, the full buffer level 343 may be considered as the pixel threshold value 342 including said overhead. In response to the pixel count value (e.g., as illustrated by the pixel count value axis 331) reaching the pixel threshold value 342, the system (e.g., via a voltage regulator, as described below with reference to FIG. 4) may switch the ISP 218 to operating at the high voltage 362.

In an aspect, if the system-on-chip 202 utilizes multiple ISPs, then the pixel threshold value 342 (e.g., ActiveWidthSlow or pixels per cycle per processor) can be calculated as demonstrated in Equation 6, where N represents the number of ISPs.

$$N * ( \frac{1}{ISPCLK 2 - ISPCLK 1} ) ( \frac{ISPCLK 1 * ISPCLK 2 * FrameWidth}{OPCLK} - \frac{ISPCLK 1 * ActiveWidth}{N} ) \qquad ( 6 )$$

In another alternative embodiment, for example, one where the high voltage level 362 for the system-on-chip 202 has yet to be determined, a chip designer may calculate a minimum required high-voltage operating point (e.g., ISPCLK2) for the system-on-chip 202 required for handling a given target power level (e.g., a pixel clock rate for the imaging sensor 208). To that end, given the equality shown in Equation 7 (which is derived based on the Equations (2)-(6), Equation 8 may be used to determine ISPCLK2 for this scenario.

$$( ISPCLK 2 * ActiveWidthSlow + ISPCLK 1 * ActiveWidthFast ) = \frac{ISPCLK 1 * ISPCLK 2 * FrameWidth}{OPCLK} , thus \text{:} \qquad ( 7 )$$

$$ISPCLK 2 = \frac{ISPCLK 1 * ActiveWidthFast}{( \frac{ISPCLK 1 * FrameWidth}{OPCLK} - ActiveWidthSlow )} \qquad ( 8 )$$

FIG. 4 illustrates an imaging device 400 (e.g., similar to that of the imaging device 100 and the imaging device 200), further illustrating functional block diagram elements for aspects that can be employed within the imaging systems disclosed herein and described in connection with FIG. 3. The imaging device 400 is an example of a device that can be configured to implement the various methods described herein. With respect to the description of FIG. 4 herein, some of the item numbers may refer to the so-numbered aspects described above in connection with one or more of FIGS. 1-3.

FIG. 4 illustrates an image signal processor (ISP) 418 operatively coupled to the memory buffer 430, the processing unit 440, and the imaging controller 450. The ISP 418 may include an ISP clock 420, which may generally correspond to the ISP clock 220 described above in connection with FIG. 2. As described above, some of the components of the system-on-chip 402 can be on a power rail A 403 and others on a power rail B 404. The power rail A 403 can be a logic power rail and the power rail B 404 can be a memory power rail, for example. The system-on-chip 402 need not include multiple power rails so as to perform the methods described herein, and/or the system-on-chip 402 may include additional power rails.

In an aspect, the memory buffer 430 can operate as a buffer for incoming pixels as described in connection with FIG. 3 (e.g., in relation to the pixel count value axis 331). The processing unit 440 can determine how a pixel count value 431 (i.e., a number of pixels in the memory buffer 430) compares with a pixel threshold value 442 further determined at the processing unit 440. In an aspect, the processing unit 440 can calculate the pixel threshold value 442 based on the set of parameters for the sensor and the set of parameters for the identified first and second voltage operating points (as described above in connection with FIG. 3), for example, as stored at the parameter table 452. The imaging controller 450 can store the parameter table 452, which can correspond to the sensor parameters related to the imaging sensor 208 as described above in connection with FIG. 3, in addition to certain of the parameters for the ISP 218, as further described above.

As illustrated, the memory buffer 430 and/or the ISP 418 can receive pixels from the imaging sensor 408. In an aspect, the ISP 418 can start at the low voltage level 361 (e.g., at the time point 322 and the sensor frame start time 311) and an amount (e.g., a first set) of the incoming pixels (e.g., as received from the memory buffer 430) can be processed at the ISP 418 immediately, while the remaining pixels (e.g., a second set) can be stored at the memory buffer 430. Thereafter (e.g., at the time point 323), when the processing unit 440 determines that the pixel count value 431 has reached the pixel threshold value 442, the processing unit 440, in connection with the imaging controller 450, the parameter table 452, and/or the voltage regulator 460, can update the parameters for the imaging sensor 208 at the parameter table 452. The imaging controller 450 can operate at a particular speed, and via a voltage regulator 460 operatively coupled to the parameter table 452, a clock source 421, a voltage source 464, and the information from the processing unit 440, the imaging controller 450 can control when and whether the ISP 418 switches between the low voltage level 361 and the high voltage level 362. In one aspect, alone (not pictured), or in connection with the imaging controller 450, the voltage regulator 460 may control when and whether the ISP 418 switches voltage operating points. In an aspect, the voltage source 464 may be tied to the power rail A 403 to provide voltage information and control to the voltage regulator 460. As mentioned above, the system-on-chip 402 may not operate on multiple power rails, instead, all of the components of the system-on-chip 402 may operate on only one power rail in some embodiments.

In an embodiment, the processing unit 440 may comprise one or more components of or fully comprise an imaging controller for the imaging device 400. As one non-limiting example, the processing unit 440 can comprise, or be included within, the imaging controller 450. Furthermore, in an embodiment, the imaging controller 450 can comprise, or be included within, the ISP 418. Thus, the imaging controller can be operationally coupled to the ISP 418 and/or the processing unit 440. Furthermore, in some embodiments, the processing unit 440, in connection with the imaging controller 450, can be located within the ISP 418.

Although a number of separate components are illustrated in FIG. 4, those of skill in the art will recognize that one or more of these components may be implemented not only with respect to the functionality described above, but also to implement the functionality described above with respect to other components. Each of the components illustrated in FIG. 4 may be implemented using a plurality of separate elements.

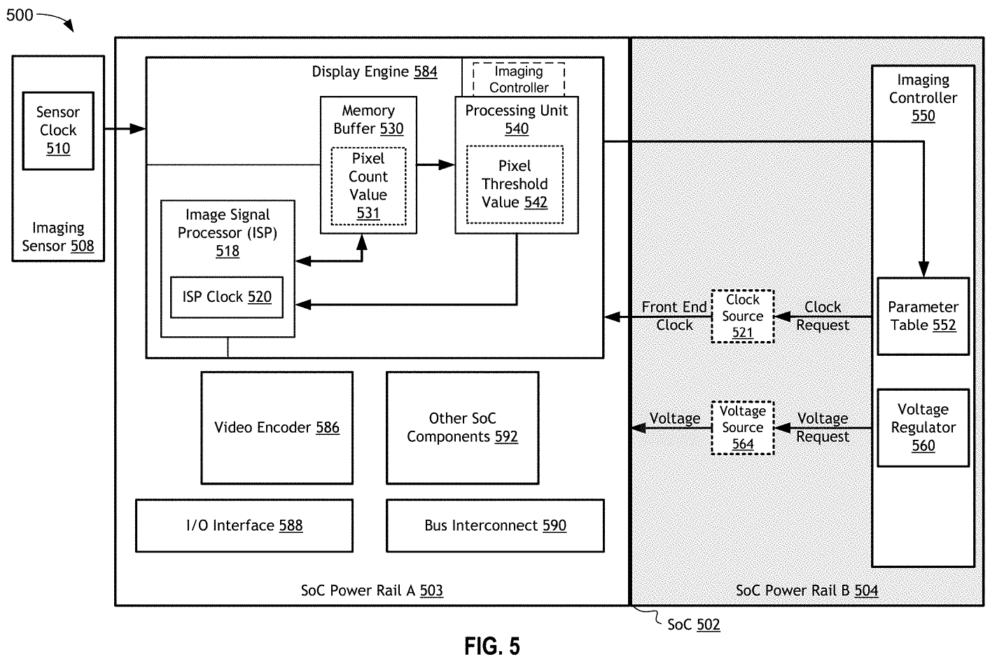

FIG. 5 illustrates an imaging device 500 (similar to that of the imaging device 100, imaging device 200, and/or the imaging device 400), further illustrating an example power rail configuration and an example data flow, as an alternative embodiment of, for example, the imaging device 400 described in connection with FIG. 4, and in accordance with one or more aspects of an implementation. The imaging device 500 is an example of a device that can be configured to implement the various methods described herein. With respect to the description of FIG. 5 herein, some of the item numbers may refer to the so-numbered aspects described above in connection with one or more of FIGS. 1-4. For example, an imaging sensor 508, a sensor clock 510, an ISP 518, an ISP clock 520, a memory buffer 530, a pixel count value 531, a processing unit 540, a pixel threshold value 542, a video encoder 586, an I/O interface 588, a bus interconnect 590, a system-on-chip (SoC) 502, an SoC power rail A 503, an SoC power rail B 504, an imaging controller 550, a parameter table 552, a voltage regulator 560, a clock source 521, and a voltage source 564, may comprise, respectively, the imaging sensor 408, the sensor clock 410, the ISP 418, the ISP clock 420, the memory buffer 430, the pixel count value 431, the processing unit 440, the pixel threshold value 442, the video encoder 486, the I/O interface 488, the bus interconnect 490, the system-on-chip (SoC) 402, the SoC power rail A 403, the SoC power rail B 404, the imaging controller 450, the parameter table 452, the voltage regulator 460, the clock source 421, and the voltage source 464, described in connection with FIG. 4.

The imaging device 500 may further include a display engine 584, which may generally correspond to the display engine 184, the display engine 284, and/or the display engine 484. However, in the alternative embodiment illustrated in FIG. 5, the display engine 584 may include a plurality of additional subcomponents. For example, the display engine 584 may include each of the ISP 518, the ISP clock 520, the memory buffer 530, and the processing unit 540. Such subcomponents may perform the same or similar operations as described above in connection with FIGS. 1-4, except included as part of the display engine 584. In an aspect, by including the systems and methods described herein for reducing lag time durations during the sensor frame time directly via the display engine 584, durations for displaying the image at the imaging device 500 may be further decreased. As one example, the imaging device 500 may comprise a standalone imaging device that benefits from rapid image display, for example, a standalone virtual reality imaging device.

Although a number of separate components are illustrated in FIG. 5, those of skill in the art will recognize that one or more of these components may be implemented not only with respect to the functionality described above, but also to implement the functionality described above with respect to other components. Each of the components illustrated in FIG. 5 may be implemented using a plurality of separate elements.

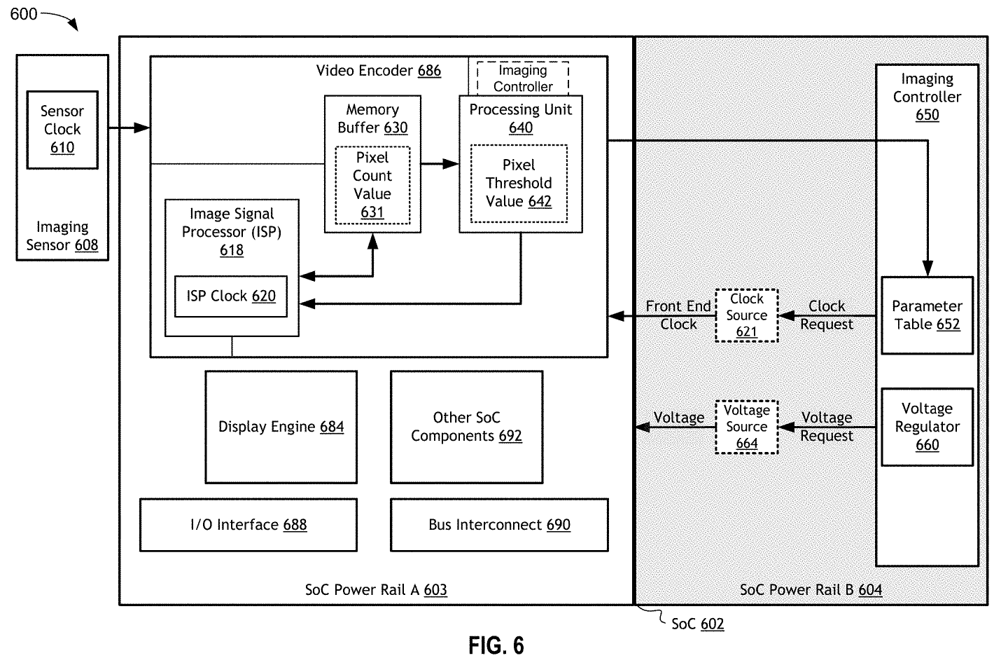

FIG. 6 illustrates an imaging device 600 (similar to that of the imaging device 100, imaging device 200, the imaging device 400, and/or the imaging device 500), further illustrating an example power rail configuration and an example data flow, as an alternative embodiment of, for example, the imaging device 400 described in connection with FIG. 4, and in accordance with one or more aspects of an implementation. The imaging device 600 is an example of a device that can be configured to implement the various methods described herein. With respect to the description of FIG. 6 herein, some of the item numbers may refer to the so-numbered aspects described above in connection with one or more of FIGS. 1-5. For example, an imaging sensor 608, a sensor clock 610, an ISP 618, an ISP clock 620, a memory buffer 630, a pixel count value 631, a processing unit 640, a pixel threshold value 642, a video encoder 686, an I/O interface 688, a bus interconnect 690, a system-on-chip (SoC) 602, an SoC power rail A 603, an SoC power rail B 604, an imaging controller 650, a parameter table 652, a voltage regulator 660, a clock source 621, and a voltage source 664, may comprise, respectively, the imaging sensor 408, the sensor clock 410, the ISP 418, the ISP clock 420, the memory buffer 430, the pixel count value 431, the processing unit 440, the pixel threshold value 442, the video encoder 486, the I/O interface 488, the bus interconnect 490, the system-on-chip (SoC) 402, the SoC power rail A 403, the SoC power rail B 404, the imaging controller 450, the parameter table 452, the voltage regulator 460, the clock source 421, and the voltage source 464, described in connection with FIG. 4, for example.

The imaging device 600 may further include a video encoder 686, which may generally correspond to the video encoder 186, the video encoder 286, the video encoder 486, and/or the video encoder 586. However, in the alternative embodiment illustrated in FIG. 6, the video encoder 686 may include a plurality of additional subcomponents. For example, the video encoder 686 may include each of the ISP 618, the ISP clock 620, the memory buffer 630, and the processing unit 640. Such subcomponents may perform the same or similar operations as described above in connection with FIGS. 1-5, except included as part of the video encoder 686. In an aspect, by including the systems and methods described herein for reducing lag time durations during the sensor frame time directly via the video encoder 686, durations for encoding video at the imaging device 600 may be further decreased. As one example, the imaging device 600 may comprise an action-based camera that benefits from rapid video encoding, for example, an Internet Protocol (IP) surveillance camera.

Although a number of separate components are illustrated in FIG. 6, those of skill in the art will recognize that one or more of these components may be implemented not only with respect to the functionality described above, but also to implement the functionality described above with respect to other components. Each of the components illustrated in FIG. 6 may be implemented using a plurality of separate elements.

FIG. 7 is an example data plot for an image signal processor (e.g., the ISP 218 as described in connection with FIG. 2) pixel rate and memory buffer fill level against time, in accordance with an implementation. The concepts described in connection with FIG. 3 with respect to the sensor frame start time 311, the low voltage level 361, the time axis 366, the empty buffer level 341, the high voltage level 362, the buffer level axis 331, etc., can generally be applied to the data plot illustrated in FIG. 7. As described above, one having ordinary skill in the art will understand that pixel rate is directly related to ISP voltage level in the context of this example. The data points illustrated in FIG. 7 can include a portion of a sensor frame time. For example, the two peaks of the memory buffer fill level line can represent two points at which the memory buffer fill level is full. In this way, FIG. 7 can represent two filling and/or draining cycles for the memory buffer the memory buffer 230.

As described above in connection with FIG. 3, a sensor (e.g., the imaging sensor 208) can send pixels to the memory buffer 230 at a constant rate (e.g., In_rate). The solid, horizontal line of FIG. 7 portrays this constant rate. In an aspect, the ISP 218 (and/or one or more of the memory buffer 230, the imaging controller 250, the processing unit 240, the voltage regulator 260, etc.) can readout pixels from the memory buffer 230 at multiple different readout rates (e.g., the pixels can be fetched from the memory buffer 230 at multiple different rates) during the sensor frame time. The readout rate can depend on the operating voltage, which can further depend on the number of operating points included within the imaging processing device 200 and/or the ISP 218. As further described above in connection with FIG. 3 and Table 1, in some aspects, a system-on-chip (e.g., the system-on-chip 202) can operate at multiple voltage operating points, for example, two, three, four, five, or more voltage operating points. The example illustrated in FIG. 7 portrays the behavior of a memory buffer (e.g., the memory buffer 230) in connection with the ISP 218 when the ISP 218 has three operating points, for example, a low operating point, a medium operating point, and a high operating point. Each of the operating points thus provide for a different readout rate (e.g., Out_rate), as illustrated by the dotted horizontal lines, which increase in readout rate directly with the operating point value. Example operating point values as described above in Table 1 in connection with FIG. 3.

As one having ordinary skill in the art will appreciate, the ISP 218 can constantly monitor (e.g., peek) the memory buffer 230 and read out a pixel if the memory buffer 230 is not empty. Thus, the imaging processing device 200 can include a pixel counter (not pictured) to count the number of pixels in the memory buffer 230. As one example, the number of pixels in the memory buffer 230 can increase if the draining rate (e.g., Out_rate described above) from the memory buffer 230 is less than the filling rate (e.g., In_rate described above). As another example, the number of pixels in the memory buffer 230 can decrease if the draining rate (e.g., Out_rate described above) from the memory buffer 230 is greater than the filling rate (e.g., In_rate described above). As described above, if the number of pixels reaches a high threshold value (e.g., one of the Out_rate levels illustrated in FIG. 7), which is less than the capacity of the memory buffer 230 in terms of a number of pixels, then the ISP 218 can switch to a higher operating rate (e.g., Out_rate), i.e., the voltage will increase, and thus, the ISP 218 will drain pixels from the memory buffer 230 faster. Once the pixel counter reaches the lower threshold (e.g., zero), the ISP 218 can switch to a lower operating rate, which will decrease the voltage to save power for the ISP 218 and/or the system-on-chip 202. In an aspect, the pixel counter can increase by one whenever an input pixel enters the memory buffer 230 and can decrease by one whenever a pixel is readout from the memory buffer 230 (e.g., by the ISP 218).

As a non-limiting example, FIG. 7 portrays the behavior of the memory buffer 230 when out_rate_med (e.g., for the medium operating point) is greater than In_rate. In one or more aspects, to avoid pixel overflow of the memory buffer 230, the ISP 218 can be configured to maintain one or more of the following formulas: In_rate*in_time≤(out_rate_low*low_time)+(out_rate_med*med_time)+(out_rate_high*high_time); In_time=low_time+med_time+high_time; Out_rate_low<in_rate; Out_rate_high>in_rate. In an aspect, out_rate_med can be greater than or less than in_rate. In another aspect, to avoid overflow of the memory buffer 230 (e.g., to drain the memory buffer 230), the ISP 218 can switch to an operating rate that is faster than in_rate, as similarly described above in connection with FIG. 3. As a non-limiting example, FIG. 7 portrays the behavior of the memory buffer 230 when out_rate_med (e.g., for the medium operating point) is greater than In_rate. As is illustrated in FIG. 7, where the example number of operating points is three, the ISP 218 and the memory buffer 230 can perform the methods described herein according to three buffer thresholds, each illustrated by the dotted horizontal lines. These Out_rate threshold lines may individually be considered functionally analogous to the buffer threshold level 342 described in connection with FIG. 3, where the example number of operating points was one.

FIG. 8 is another example data plot for an image signal processor (e.g., the ISP 218 as described in connection with FIG. 2) pixel rate and memory buffer fill level against time, in accordance with an implementation. The same general concepts as described above in connection with FIG. 7 apply in connection with the data plot illustrated in FIG. 8, except that in the example of FIG. 8, out_rate_med is less than in_rate. Thus, as a non-limiting example, FIG. 8 portrays the behavior of the memory buffer 230 when out_rate_med (e.g., for the medium operating point) is less than In_rate. Again, to avoid overflow of the memory buffer 230 (e.g., to drain the memory buffer 230), the ISP 218 can switch to an operating rate that is faster than in_rate, as similarly described above in connection with FIG. 3. As is illustrated in FIG. 8, where the example number of operating points is three, the ISP 218 and the memory buffer 230 can perform the methods described herein according to three buffer thresholds, each illustrated by the dotted horizontal lines. These Out_rate threshold lines may individually be considered functionally analogous to the buffer threshold level 342 described in connection with FIG. 3, where the example number of operating points was one.

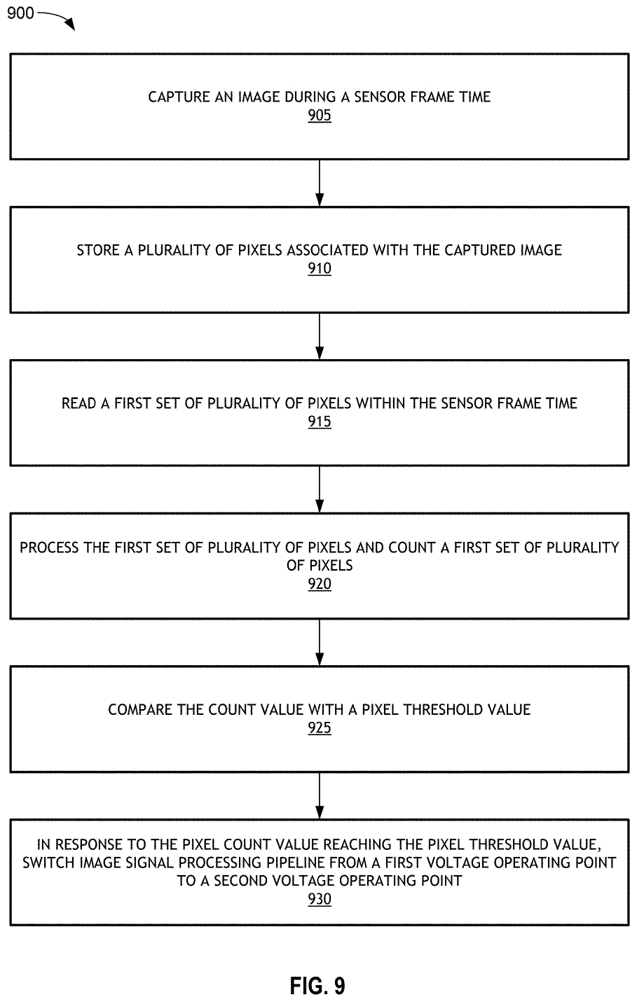

FIG. 9 is a flowchart of a method for switching voltage operating points of an image signal processing pipeline, in accordance with an implementation. At a step 905, the method comprises capturing an image during a sensor frame time. At a step 910, the method further comprises storing a plurality of pixels associated with the captured image. At a step 915, the method further comprises reading a first set of plurality of pixels within the sensor frame time. At a step 920, the method further comprises processing the first set of plurality of pixels and count a first set of plurality of pixels. At a step 925, the method further comprises comparing the count value with a pixel threshold value. At a step 930, the method further comprises, in response to the pixel count value reaching the pixel threshold value, switching the image signal processing pipeline from a first voltage operating point to a second voltage operating point.

In one example, means for capturing may comprise the imaging device 400 via the imaging sensor 408 and/or the sensor clock 410. In one example, means for identifying may comprise the imaging device 400 via the voltage regulator 460 in connection with one the parameter table 452 and/or the imaging controller 450. In one example, means for receiving and/or means for storing may comprise the imaging device 400 via the memory buffer 430 and/or the ISP 418. In one example, means for comparing, means for processing, means for reading, means for calculating, and/or means for deducting, means for reading out pixels, among other means, may comprise the imaging device 400 via the processing unit 440 in connection with the memory buffer 430. In one example, means for displaying may comprise the imaging device 400 via the display engine 484. In another example, means for displaying may comprise the imaging device 500 via the display engine 584. In one example, means for encoding may comprise the imaging device 400 via the video encoder 486. In another example, means for encoding may comprise the imaging device 600 via the video encoder 686. Although such non-limiting example means refer to certain of the aspects of FIGS. 4-6, the various means described herein may comprise one or more of the similarly numbered, or otherwise, aspects of any one or more of FIGS. 1-9 described above.

As used herein, the term “determining” and/or “identifying” encompass a wide variety of actions. For example, “determining” and/or “identifying” may include calculating, computing, processing, deriving, choosing, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, identifying, establishing, selecting, choosing, determining and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

As used herein, the term interface may refer to hardware or software configured to connect two or more devices together. For example, an interface may be a part of a processor or a bus and may be configured to allow communication of information or data between the devices. The interface may be integrated into a chip or other device. For example, in some embodiments, an interface may comprise a receiver configured to receive information or communications from a device at another device. The interface (e.g., of a processor or a bus) may receive information or data processed by an ISP, a front end, or another device or may process information received. In some embodiments, an interface may comprise a transmitter configured to transmit, provide, or communicate information or data to another device. Thus, the interface may transmit information or data or may prepare information or data for outputting for transmission (e.g., via a bus).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) signal or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, imaging controller, microcontroller, state machine, or otherwise. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and Blu-ray® disc where disks usually reproduce data magnetically, while discs reproduce data optically with lasers. Thus, in some aspects, computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by an imaging device 100, an imaging device 200, an imaging device 400, a system-on-chip 102, a system-on-chip 202, a system-on-chip 402, an ISP 118, an ISP 218, an ISP 418, an imaging sensor 108, an imaging sensor 208, an imaging sensor 408, and/or another device as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an imaging device 100, an imaging device 200, an imaging device 400, and/or another device can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method for switching voltage operating points of an image signal processing pipeline, the method comprising:
capturing an image during a sensor frame time;
storing a plurality of pixels associated with the captured image;
reading a first set of plurality of pixels within the sensor frame time;
processing the first set of plurality of pixels and count a first set of plurality of pixels;
comparing the count value with a pixel threshold value; and
in response to the pixel count value reaching the pixel threshold value, switching the image signal processing pipeline from a first voltage operating point to a second voltage operating point.

2. The method of claim 1, further comprising calculating the pixel threshold value based on a set of parameters for a sensor and a set of parameters for the first and second voltage operating points.

3. The method of claim 2, wherein the set of parameters for the sensor includes one or more of a pixel clock rate, a frame width, and an active pixel width, and wherein the set of parameters for the first and second voltage operating points includes one or more of a voltage level and a maximum clock frequency.

4. The method of claim 1, further comprising:
in response to the pixel count value reaching the pixel threshold value, processing a second set of plurality of pixels; and
deducting from the pixel count value each pixel processed in the second set of plurality of pixels until the pixel count value reaches zero.

5. The method of claim 4, further comprising, in response to the pixel count value reaching zero, switching the image signal processing pipeline back to operating at the first voltage operating point.

6. The method of claim 1, further comprising storing small portions of the image in accordance with a memory storage capability, such that a lag time duration for displaying the image is reduced to within a sensor frame time.

7. The method of claim 1, further comprising reading-out pixels from a memory buffer at a first readout rate corresponding to the first voltage operating point and at a second readout rate corresponding to the second voltage operating point.

8. The method of claim 7, further comprising reading-out pixels at one or more additional readout rates, each of the one or more additional readouts rates corresponding to one or more additional voltage operating points different from either of the first and second voltage operating points.

9. An apparatus comprising:
a sensor configured to capture an image during a sensor frame time;
a memory buffer configured to store a plurality of pixels associated with the captured image;
an image signal processing pipeline operating at a first voltage operating point, including a processing unit, coupled to the memory buffer and configured to read a first set of plurality of pixels within the sensor frame time, process the first set of plurality of pixels and count a first set of plurality of pixels and compare the count value with a pixel threshold value; and
a voltage regulator, coupled to the image signal processing pipeline, configured to, in response to the pixel count value reaching the pixel threshold value, switch the image signal processing pipeline from a first voltage operating point to a second voltage operating point.

10. The apparatus of claim 9, further comprising a display engine including a plurality of subcomponents, wherein the ISP, the memory buffer, and the processing unit each comprise one of the plurality of subcomponents.

11. The apparatus of claim 9, further comprising a video encoder including a plurality of subcomponents, wherein the ISP, the memory buffer, and the processing unit each comprise one of the plurality of subcomponents.

12. The apparatus of claim 9, wherein the processing unit is further configured to calculate the pixel threshold value based on a set of parameters for the sensor and a set of parameters for the identified first and second voltage operating points.

13. The apparatus of claim 12, wherein the set of parameters for the sensor includes one or more of a pixel clock rate, a frame width, and an active pixel width, and wherein the set of parameters for the identified first and second voltage operating points includes one or more of a voltage level and a maximum clock frequency.

14. The apparatus of claim 9, wherein the image signaling processing pipeline is further configured to, in response to the pixel count value reaching the pixel threshold value, process a second set of plurality of pixels, and the processing unit is further configured to deduct from the pixel count value each pixel processed in the second set of plurality of pixels until the pixel count value reaches zero.

15. The apparatus of claim 14, wherein the voltage regulator is further configured to, in response to the pixel count value reaching zero, switch the image signal processing pipeline back to operating at the first voltage operating point.

16. The apparatus of claim 15, wherein the memory buffer stores small portions of the image in accordance with a memory storage capability of the memory buffer, such that a lag time duration for displaying the image is reduced to within the sensor frame time.

17. The apparatus of claim 9, wherein the apparatus comprises an imaging controller, coupled to the processor, and wherein the imaging controller includes the processing unit.

18. The apparatus of claim 9, wherein the sensor sends pixels to the memory buffer at a constant rate, and wherein the processing unit reads-out pixels from the memory buffer at a first readout rate corresponding to the first voltage operating point and at a second readout rate corresponding to the second voltage operating point.

19. The apparatus of claim 18, wherein the image signal processing pipeline operates at one or more additional voltage operating points, and wherein the processing unit reads-out pixels from the memory buffer at one or more additional readout rates, each of the one or more additional readouts rates corresponding to one of the one or more additional voltage operating points.

20. The apparatus of claim 10, wherein the apparatus is a standalone virtual reality imaging device.

21. The apparatus of claim 11, wherein the apparatus is an action camera device.

22. An apparatus for switching voltage operating points of an image signal processing pipeline, the apparatus comprising:
means for capturing an image during a sensor frame time;
means for storing a plurality of pixels associated with the captured image;
means for processing configured to:
read a first set of plurality of pixels within the sensor frame time;
process the first set of plurality of pixels and count a first set of plurality of pixels; and
compare the count value with a pixel threshold value; and
means for, in response to the pixel count value reaching the pixel threshold value, switching the image signal processing pipeline from a first voltage operating point to a second voltage operating point.

23. The apparatus of claim 22, wherein the means for processing is further configured to calculate the pixel threshold value based on a set of parameters for a sensor and a set of parameters for the first and second voltage operating points.

24. The apparatus of claim 23, wherein the set of parameters for the sensor includes one or more of a pixel clock rate, a frame width, and an active pixel width, and wherein the set of parameters for the first and second voltage operating points includes one or more of a voltage level and a maximum clock frequency.

25. The apparatus of claim 22, wherein the means for processing is further configured to:
in response to the pixel count value reaching the pixel threshold value, process a second set of plurality of pixels; and
deduct from the pixel count value each pixel processed in the second set of plurality of pixels until the pixel count value reaches zero.

26. The apparatus of claim 25, wherein the means for switching is further configured to, in response to the pixel count value reaching zero, switch the image signal processing pipeline back to operating at the first voltage operating point.

27. The apparatus of claim 22, wherein the means for storing is further configured to store small portions of the image in accordance with a memory storage capability, such that a lag time duration for displaying the image is reduced to within a sensor frame time.

28. The apparatus of claim 22, wherein the means for processing is further configured to readout pixels from the means for storing at a first readout rate corresponding to the first voltage operating point and at a second readout rate corresponding to the second voltage operating point.

29. The apparatus of claim 28, wherein the means for processing is further configured to readout pixels at one or more additional readout rates, each of the one or more additional readouts rates corresponding to one or more additional voltage operating points different from either of the first and second voltage operating points.
